(19) United States
(12) Patent Application Publication
(10) Pub. No.: US 2009/0244750 A1
(43) Pub. Date: Oct. 1, 2009

(54) MAGNETIC-RECORDING-MEDIUM TESTING APPARATUS, MAGNETIC-RECORDING-MEDIUM TESTING METHOD, AND MAGNETIC RECORDING APPARATUS

(75) Inventor: Motomichi Shibano, Kanagawa (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/331,221

(22) Filed: Dec. 9, 2008

(30) Foreign Application Priority Data
Mar. 31, 2008 (JP) 2008-092976

(51) Int. Cl. G11B 5/02

(52) U.S. Cl. 360/25; G9B/5.026

(57) ABSTRACT

A magnetic-recording-medium testing apparatus includes a frequency-characteristic analyzing unit that analyzes a frequency characteristic of a reproduced signal in an area of a magnetic material where a continuous frequency signal is written, in a magnetic recording medium that records a signal according to a magnetization direction of the magnetic material, a signal-amplitude comparing unit that compares signal amplitudes of a fundamental wave and a higher harmonic wave with each other based on the frequency characteristic analyzed by the frequency-characteristic analyzing unit, to estimate a cross sectional shape pattern of the magnetic recording medium, and a performance-quality determining unit that determines performance quality of the magnetic recording medium based on the cross sectional shape pattern of the magnetic recording medium estimated by the signal-amplitude comparing unit.

### CROSS-REFERENCE TO RELATED APPLICATION(S)

This application is based upon and claims the benefit of priority of the prior Japanese Patent Application No. 2008-092976, filed on Mar. 31, 2008, the entire contents of which are incorporated herein by reference.

### FIELD

The embodiments discussed herein are directed to a magnetic-recording-medium testing apparatus, a magnetic-recording-medium testing method, and a magnetic recording apparatus.

### BACKGROUND

Conventionally, a high transfer rate and a large capacity are wanted in a magnetic recording apparatus having a magnetic recording medium to match with an improved processing performance of a computer. The high transfer rate and large capacity of the magnetic recording apparatus may be achieved by setting parameters of the magnetic recording medium to optimal values at a time of shipping inspection, or by effectively utilizing the recording area (recording density) of the magnetic recording medium.

A manufacturing and testing procedure of the magnetic recording medium is explained with reference to FIG. 12. FIG. 12 is a flowchart for explaining an example of a manufacturing and testing procedure of a magnetic recording medium according to a conventional technique. As shown in FIG. 12, when a base plate is loaded (YES at Step S11), a magnetic-recording-medium testing apparatus grinds and cleans the base plate (Step S12). The magnetic-recording-medium testing apparatus then forms a film of a magnetic material, applies a lubricant to the magnetic recording medium for surface treatment, and executes tape burnishing (Steps S13 to S15). Subsequently, the magnetic-recording-medium testing apparatus executes a surface smoothness test (Step S16) of the magnetic recording medium, an electromagnetic property test (Step S17), and other tests as necessary. Thereafter, the magnetic recording medium is packed and shipped (Step S18).

Recently, to reduce the time required for writing servo signal information in the magnetic recording medium, various kinds of technique have been studied. One type of such techniques is a magnetic transfer system according to which the servo signal information is magnetically duplicated to the medium and thus recorded. Another type is a physical transfer system according to which the servo signal information is physically embossed to the medium: the physical transfer system includes, for example, a discrete track recording system and a patterned media recording system. According to the discrete track recording system, a nonmagnetic material area is formed between adjacent tracks, and information is recorded only on a track formed by a magnetic material, to improve the recording density or suppress degradation of a signal quality. Compared with the discrete track recording system, the patterned media recording system improves recording resolution by isolating a magnetic domain particle and creating a single bit pattern.

The quality of each magnetic recording medium thus manufactured is checked during shipping inspection after the magnetic recording medium is loaded on a magnetic recording apparatus and assembled, which requires a large number of man-hour and drags on production efficiency. Therefore, when the servo signals are formed through patterning which creates the structure of the magnetic recording medium, quality check of the servo signal may preferably be performed during manufacturing of the magnetic recording medium.

According to Japanese Patent Application Laid-open No. 2001-291234, the quality of servo signal information is checked based on a magnetic duplicated pattern created for performance evaluation. More specifically, according to this technique, a signal pattern having two different frequencies respectively of a long wavelength and a short wavelength is created, subjected to magnetic transfer, and reproduced. Subsequently, intensities of the reproduced and detected signal amplitude are compared. This technique determines that the performance of the magnetic duplicate system is satisfactory when each of the intensities exceeds a predetermined threshold.

However, the conventional technique has a problem in that it requires a large man-hour for checking the quality of patterning of the magnetic material. Further, the conventional technique has a problem in that a servo operation is unstable when the magnetic recording medium is loaded on the magnetic recording apparatus.

Specifically, in Japanese Patent Application Laid-open No. 2001-291234, the product is evaluated based on a pattern which is formed for checking the duplicate performance of signals other than the servo signal. Hence, the quality of all areas of the magnetic recording medium cannot be checked based on this pattern. Further, the pattern for evaluation is formed in the recording area of the magnetic recording medium, causing decrease in use efficiency of areas of the magnetic recording medium.

Further, the discrete track recording system and the patterned media recording system require time for adjusting control parameters and performing filter setting for on-track processing, according to which tracks are properly followed. Furthermore, the magnetic recording medium loaded in the magnetic recording apparatus may deform, for example, during a physical etching process. Then, an optimum characteristic setting value for the servo operation may not be obtained.

### SUMMARY

It is an object of the present invention to at least partially solve the problems in the conventional technology.

According to one aspect of an embodiment, a magnetic-recording-medium testing apparatus includes a frequency-characteristic analyzing unit that analyzes a frequency characteristic of a reproduced signal in an area of a magnetic material where a continuous frequency signal is written, in a magnetic recording medium that records a signal according to a magnetization direction of the magnetic material, a signal-amplitude comparing unit that compares signal amplitudes of a fundamental wave and a higher harmonic wave with each other based on the frequency characteristic analyzed by the frequency-characteristic analyzing unit, to estimate a cross sectional shape pattern of the magnetic recording medium, and a performance-quality determining unit that determines performance quality of the magnetic recording medium based on the shape pattern of the magnetic recording medium estimated by the signal-amplitude comparing unit.

According to another aspect of an embodiment, a magnetic recording apparatus that records a signal according to a magnetization direction of a magnetic material, includes a frequency-characteristic analyzing unit that analyzes a frequency characteristic of a reproduced signal in an area of the magnetic material where a continuous frequency signal is written, a signal-amplitude comparing unit that compares signal amplitudes of a fundamental wave and a higher harmonic wave with each other in the frequency characteristic analyzed by the frequency-characteristic analyzing unit, and a characteristic-set-value determining unit that determines set values of filter characteristics and equalizer characteristics for demodulating a magnetic recording signal according to characteristics obtained by comparison performed by the signal-amplitude comparing unit, stores the determined set values in a predetermined memory area, and demodulates a servo signal based on the determined set values.

According to still another aspect of an embodiment, a magnetic-recording-medium testing method includes analyzing a frequency characteristic of a reproduced signal in an area of a magnetic material where a continuous frequency signal is written, in a magnetic recording medium that records a signal according to a magnetization direction of the magnetic material, comparing signal amplitudes of a fundamental wave and a higher harmonic wave with each other based on the frequency characteristic analyzed in the analyzing, to estimate a cross sectional shape pattern of the magnetic recording medium, and determining performance quality of the magnetic recording medium based on the shape pattern of the magnetic recording medium estimated in the comparing.

Additional objects and advantages of the invention (embodiments) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 schematically depicts characteristics of a magnetic-recording-medium testing apparatus according to a first embodiment of the present invention;

FIG. 2 depicts a configuration of the magnetic-recording-medium testing apparatus according to the first embodiment;

FIG. 3 is a waveform example of a reproduced signal obtained from a preamble part of a servo signal;

FIG. 4A is an example of a reproduced signal waveform and frequency characteristics of a magnetic layer with a normal cross sectional shape pattern;

FIG. 4B is an example of a reproduced signal waveform and frequency characteristics of a magnetic layer with a cross sectional shape pattern having a shaved magnetic film;

FIG. 4C is an example of a reproduced signal waveform and frequency characteristics of a magnetic layer with a narrowed cross sectional shape pattern;

FIG. 5A is an example of frequency characteristics obtained from a reproduced signal when a medium is normal;

FIG. 5B is an example of frequency characteristics obtained from a reproduced signal when a medium is defective;

FIG. 6 is a flowchart for explaining a manufacturing and testing procedure example of a magnetic recording medium according to the first embodiment;

FIG. 7 depicts a configuration of a magnetic recording apparatus according to a second embodiment of the present invention;

FIG. 8 is a flowchart for explaining a servo-characteristic-optimization process procedure performed by the magnetic recording apparatus according to the second embodiment;

FIG. 9A is a schematic diagram for explaining an example in which a servo set value according to a third embodiment of the present invention is recorded in a servo area;

FIG. 9B is an example of a magnetic recording medium according to the third embodiment;

FIG. 10 is a timing chart of a servo signal optimization process according to a fourth embodiment of the present invention at the time of a device operation;

FIG. 11 depicts a computer that executes a magnetic-recording-medium testing program;

FIG. 12 is a flowchart for explaining an example of a manufacturing and testing procedure of a magnetic recording medium according to a conventional technique;

FIG. 13 is a configuration example of the magnetic recording apparatus according to the conventional technique.

### DESCRIPTION OF EMBODIMENTS

Exemplary embodiments of a magnetic-recording-medium testing apparatus according to the present invention will be explained below in detail with reference to the accompanying drawings. An overview and characteristics of the magnetic-recording-medium testing apparatus, a configuration of the magnetic-recording-medium testing apparatus, and a processing flow will be explained in this order, and effects achieved by the embodiments will be explained last.

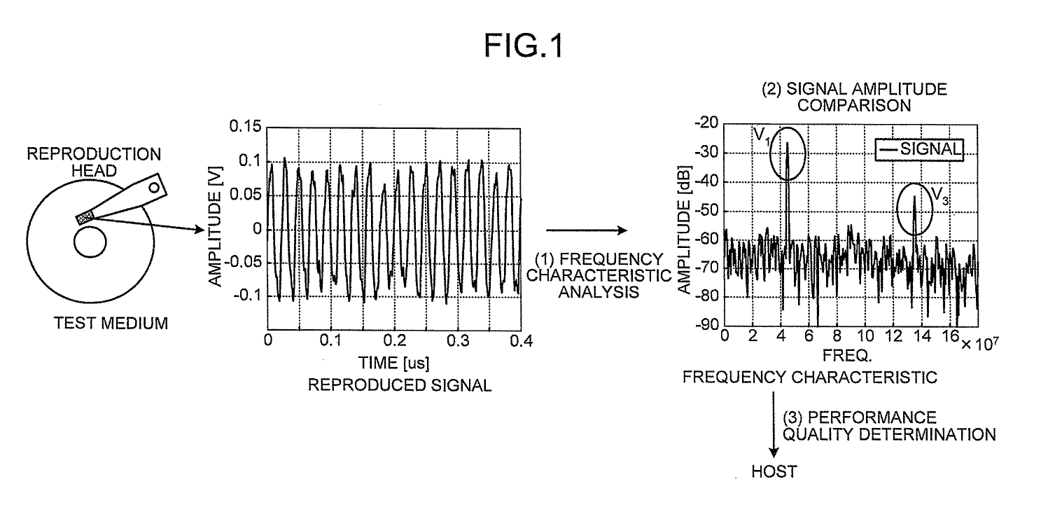

First, overview and characteristics of the magnetic-recording-medium testing apparatus according to a first embodiment of the present invention are explained with reference to FIG. 1. FIG. 1 schematically depicts characteristics of the magnetic-recording-medium testing apparatus.

The magnetic-recording-medium testing apparatus performs quality testing of a magnetic recording medium when a test medium, i.e., the magnetic recording medium that records and reproduces predetermined data is inserted therein. The magnetic-recording-medium testing apparatus outputs a result of the quality testing to a controlling PC (host) or the like connected thereto.

The magnetic-recording-medium testing apparatus with the above configuration performs performance check of the magnetic recording medium that records a signal according to a magnetization direction of a magnetic material. Specifically, the magnetic-recording-medium testing apparatus can perform quality testing of the patterning of a magnetic material at a high speed, and stabilize a servo operation performed when the magnetic recording medium is loaded in the magnetic recording apparatus.

More specifically, the magnetic-recording-medium testing apparatus analyzes frequency characteristics of a reproduced signal of an area of the magnetic material in which a continuous frequency signal is written (see (1) in FIG. 1). The magnetic-recording-medium testing apparatus obtains a reproduced signal of a preamble part, which is a top single frequency domain, of a servo signal. The servo signal is used for a positioning control of a reproduction head of the magnetic recording medium. The magnetic-recording-medium testing apparatus then analyzes the frequency characteristics of the obtained reproduced signal by Discrete Fourier Transform (DFT) calculation.

The magnetic-recording-medium testing apparatus compares signal amplitudes of a fundamental wave and a higher harmonic wave with each other based on the analyzed frequency characteristics, to estimate a cross sectional shape pattern of the magnetic recording medium (see (2) in FIG. 1). Specifically, the magnetic-recording-medium testing apparatus compares a fundamental wave “V₁” having a high signal intensity with a third-harmonic wave “V₃”. The magnetic-recording-medium testing apparatus then estimates the cross sectional shape pattern of the magnetic recording medium from an intensity ratio between the fundamental wave “V₁” and the third-harmonic wave “V₃”.

Subsequently, the magnetic-recording-medium testing apparatus determines the quality of performance of the magnetic recording medium based on the estimated cross sectional shape pattern of the magnetic recording medium (see (3) in FIG. 1). When the fundamental wave “V₁”, and the third-harmonic wave “V₃” are in a predetermined intensity ratio, the magnetic-recording-medium testing apparatus estimates that the magnetic recording medium has a normal shape pattern and outputs a determination result to a host. When the fundamental wave “V₁” and the third-harmonic wave “V₃” are not in the predetermined intensity ratio, the magnetic-recording-medium testing apparatus estimates that the magnetic recording medium has a defective shape pattern, and outputs a determination result to the host.

Accordingly, on performing the performance check of the magnetic recording medium that records the signal according to the magnetization direction of the magnetic material, the magnetic-recording-medium testing apparatus according to the first embodiment analyzes the frequency characteristics of the reproduced signal of the preamble part of the servo signal, to estimate the cross sectional shape pattern of the magnetic recording medium based on the frequency characteristics. As a result, the magnetic-recording-medium testing apparatus can perform the quality testing of the patterning of the magnetic material at a high speed and stabilize the servo operation performed when the magnetic recording medium is loaded in the magnetic recording apparatus.

On performing the performance check of the magnetic recording medium that records the signal according to the magnetization direction of the magnetic material, the magnetic-recording-medium testing apparatus uses the preamble part of the servo signal for which the filter setting for on-track processing and parameter setting for positioning control involved with the medium test are not required. Therefore, the magnetic-recording-medium testing apparatus can perform the quality testing of the patterning of the magnetic material at a higher speed as compared with a conventional technique in which adjustment such as filter setting for the track-following positioning control and the parameter setting for the control is required.

Further, the magnetic-recording-medium testing apparatus estimates the cross sectional shape pattern of the medium by using the preamble part of the servo signal having no physical effect on a magnetic layer, and outputs information indicating whether the performance is normal or defective. Therefore, the servo operation performed when the magnetic recording medium is loaded in the magnetic recording apparatus can be stabilized as compared with the conventional technique in which the pattern shape of the magnetic layer recorded on the medium deforms due to a physical etching process, thereby causing a change in the servo signal characteristic.

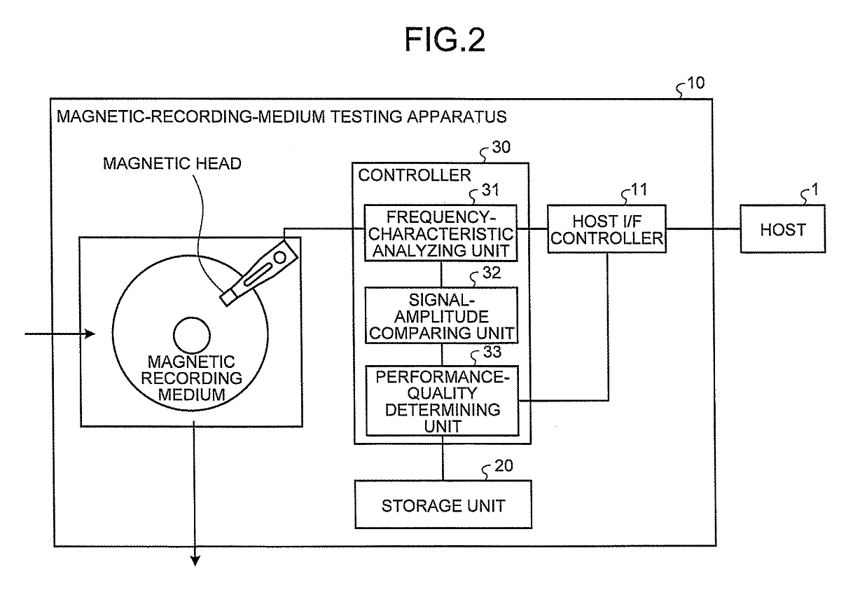

The configuration of the magnetic-recording-medium testing apparatus is explained next with reference to FIG. 2. FIG. 2 depicts a configuration of the magnetic-recording-medium testing apparatus.

As depicted in FIG. 2, a magnetic-recording-medium testing apparatus 10 includes a host interface (I/F) controller 11, a storage unit 20, and a controller 30. When a host 1 connected to the magnetic-recording-medium testing apparatus 10 performs control for the performance check of the magnetic recording medium, the magnetic-recording-medium testing apparatus 10 performs the performance check of the magnetic recording medium inserted therein.

The host I/F controller 11 accepts performance check control of the magnetic recording medium from the host 1 connected to the host I/F controller 11 and outputs the performance check result to the host 1. The storage unit 20 records data required for various processes performed by the controller 30 and various processing results by the controller 30.

The controller 30 includes an internal memory for storing a program specifying various process procedures and required data, and also includes a frequency-characteristic analyzing unit 31, a signal-amplitude comparing unit 32, and a performance-quality determining unit 33 as units closely associated with the present invention, and executes various processes by using these units.

The frequency-characteristic analyzing unit 31 analyzes the frequency characteristics of the reproduced signal of an area of the magnetic material where a continuous frequency signal is written. Specifically, the frequency-characteristic analyzing unit 31 obtains the reproduced signal of the preamble part, which is a top single frequency domain, of the servo signal used for the positioning control of the reproduction head of the magnetic recording medium. The frequency-characteristic analyzing unit 31 analyzes the frequency characteristics by the DFT calculation based on the obtained reproduced signal.

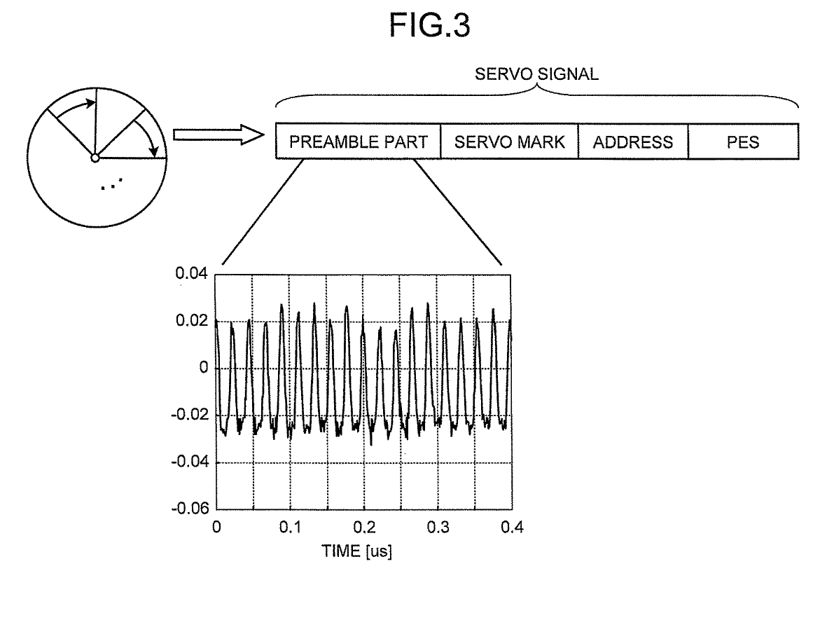

The reproduced signal obtained by the frequency-characteristic analyzing unit 31 is, as shown in FIG. 3, a servo signal recorded according to the magnetization direction of the magnetic material of the magnetic recording medium. A frame of the servo signal includes the preamble part in which the single frequency signal is written, a servo mark in which sector information is written, an address in which track address information is written, and a burst signal part in which a burst signal for detecting a position error signal (PES) is written. The frequency-characteristic analyzing unit 31 obtains the reproduced signal from the preamble part of the frame of the servo signal. FIG. 3 illustrates a waveform example of the reproduced signal obtained from the preamble part of the servo signal.

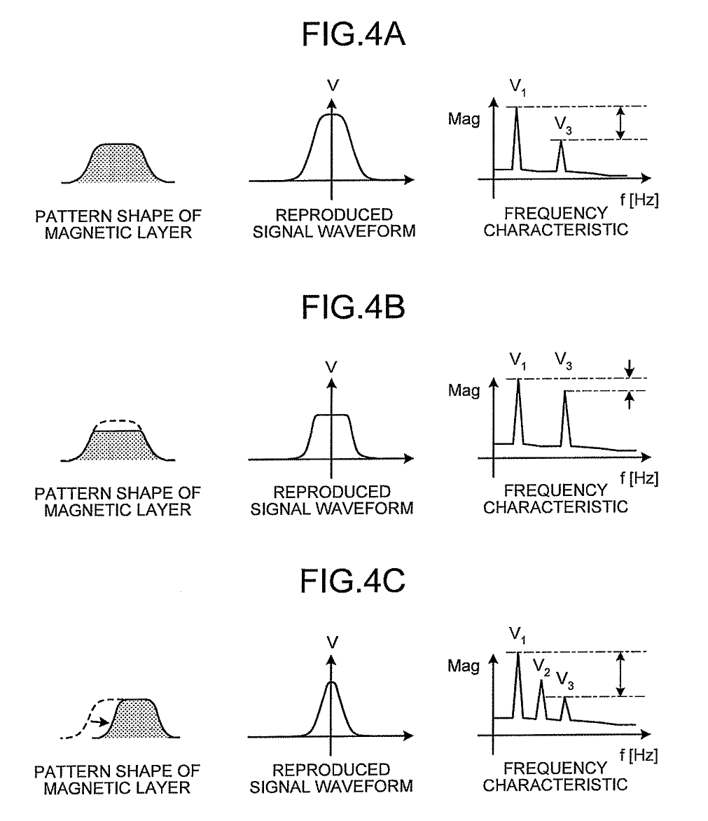

The signal-amplitude comparing unit 32 compares the signal amplitudes of the fundamental wave and the higher harmonic wave with each other based on the frequency characteristics analyzed by the frequency-characteristic analyzing unit 31 to estimate the cross sectional shape pattern of the magnetic recording medium. For example, the signal-amplitude comparing unit 32 compares the fundamental wave “V₁” having high signal intensity with the third-harmonic wave “V₃” based on the frequency characteristics analyzed by the frequency-characteristic analyzing unit 31 (see FIGS. 4A to 4C). The signal-amplitude comparing unit 32 estimates the cross sectional shape pattern of the magnetic recording medium based on the intensity ratio between the fundamental wave “V₁” and the third-harmonic wave “V₃”.

An example of the frequency characteristics of a magnetic material with a normal cross sectional shape pattern is depicted in FIG. 4A. As illustrated in FIG. 4A, the fundamental wave “V₁” and the third-harmonic wave “V₃” are in a predetermined intensity ratio. FIG. 4A is an example of a reproduced signal waveform and the frequency characteristics of a magnetic material with a normal cross sectional shape pattern.

An example of the frequency characteristic of a magnetic material with a shaved magnetic film is depicted in FIG. 4B. As illustrated in FIG. 4B, the component of the fundamental wave “V₁” decreases and the component of the third-harmonic wave “V₃” increases. In the cross sectional shape pattern with the shaved magnetic film, the intensity ratio between the fundamental wave “V₁” and the third-harmonic wave “V₃” is not of a predetermined level. FIG. 4B is an example of a reproduced signal waveform and the frequency characteristics of a magnetic material with a cross sectional shape pattern having a shaved magnetic film.

An example of the frequency characteristics of a magnetic material with a narrowed cross sectional shape pattern is depicted in FIG. 4C. As illustrated in FIG. 4C, second harmonic wave “V₂”, which is an even harmonic wave, becomes higher than a reference value, in addition to the fundamental wave “V₁” and the third-harmonic wave “V₃”. The second harmonic wave “V₂” appears not only when the magnetic material is narrowed but also when the magnetic material is widened. FIG. 4C is an example of a reproduced signal waveform and the frequency characteristics of a magnetic material with a narrowed cross sectional shape pattern.

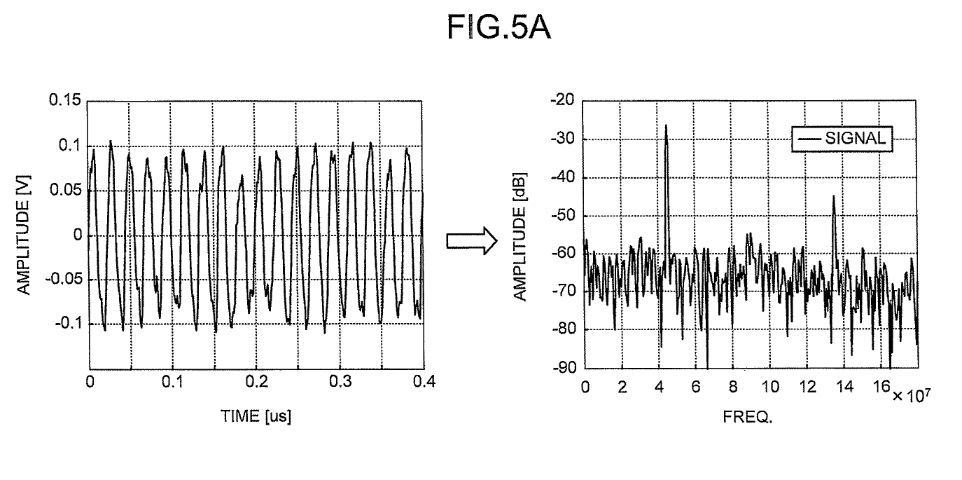

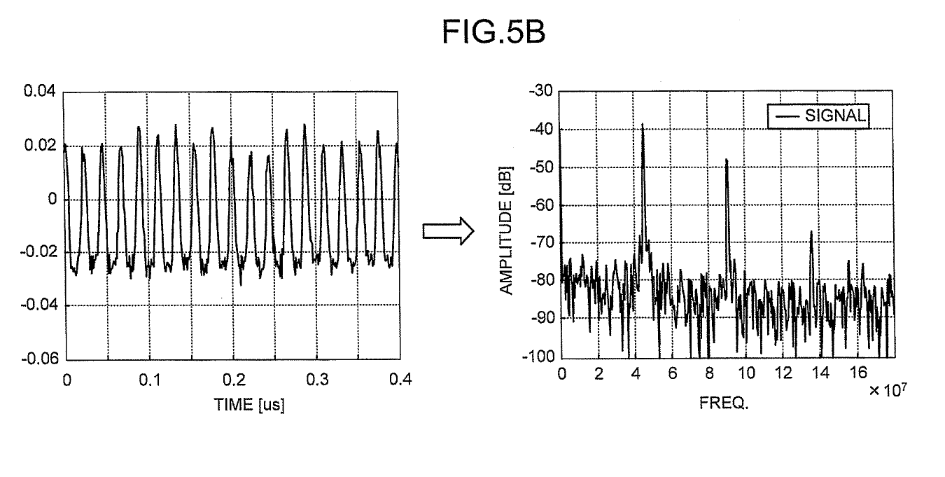

The performance-quality determining unit 33 determines the quality of the performance of the magnetic recording medium based on the cross sectional shape pattern of the magnetic recording medium estimated by the signal-amplitude comparing unit 32. When the fundamental wave “V₁” and the third-harmonic wave “V₃” are in the predetermined intensity ratio (see FIG. 5A), the signal-amplitude comparing unit 32 estimates that the cross sectional shape pattern is normal, and the performance-quality determining unit 33 determines that the cross sectional shape pattern is normal based on the estimated cross sectional shape pattern and outputs information indicating that the magnetic recording medium is normal to the host 1. When the cross sectional shape pattern of the magnetic material is normal, the reproduced signal waveform becomes a sine wave.

When the fundamental wave “V₁” and the third-harmonic wave “V₃” are not in the predetermined intensity ratio (see FIG. 5B), the signal-amplitude comparing unit 32 estimates that the cross sectional shape pattern is defective, and the performance-quality determining unit 33 determines that the cross sectional shape pattern is defective based on the estimated cross sectional shape pattern and outputs information indicating that the magnetic recording medium is defective to the host 1. In the frequency characteristics when the reproduced signal waveform is a triangular wave, an even order (second) harmonic wave appears due to an influence of a strain component in the signal waveform. FIG. 5A is an example of the frequency characteristics obtained from the reproduced signal when the medium is normal, and FIG. 5B is an example of the frequency characteristics obtained from the reproduced signal when the medium is defective.

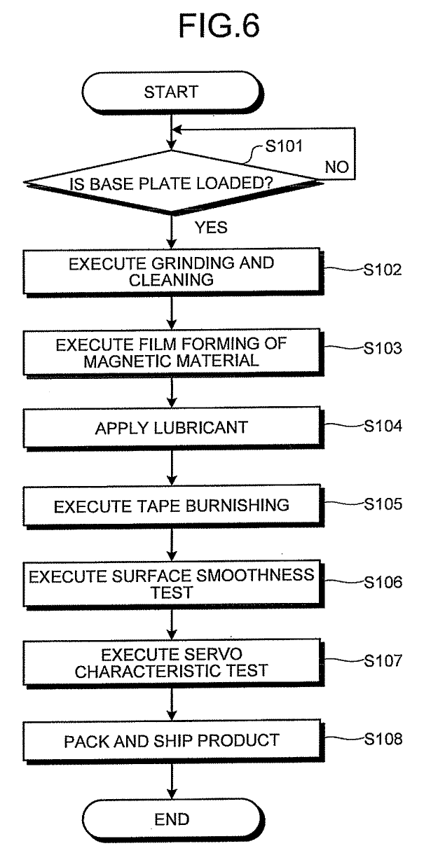

Manufacturing and testing of the magnetic recording medium are explained next with reference to FIG. 6. FIG. 6 is a flowchart for explaining a manufacturing and testing procedure example of the magnetic recording medium according to the first embodiment. As shown in FIG. 6, when a base plate is loaded (YES at Step S101), the magnetic-recording-medium testing apparatus 10 executes grinding and cleaning of the base plate (Step S102).

The magnetic-recording-medium testing apparatus 10 then executes film forming of a magnetic material, application of a lubricant for surface treatment of the magnetic recording medium, and a tape burnish process (Steps S103 to S105). When film forming of the magnetic material is executed, a servo signal to be used for performance check is generated.

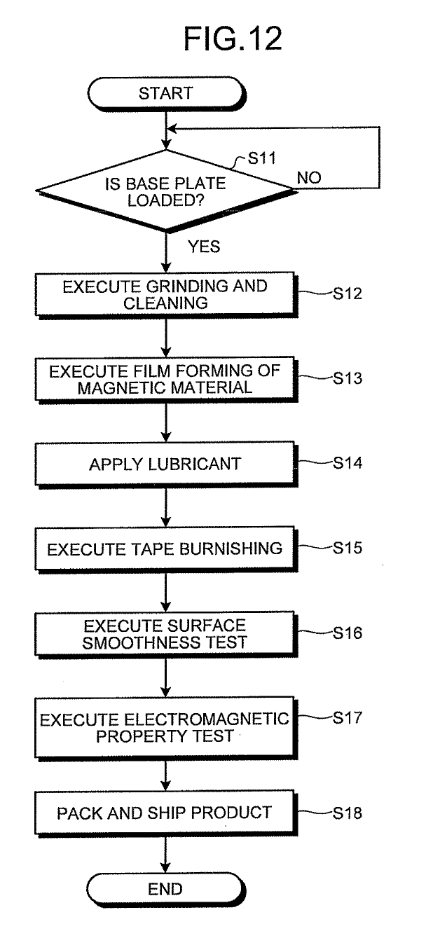

Subsequently, the magnetic-recording-medium testing apparatus 10 executes a surface smoothness test of the magnetic recording medium (Step S106), a servo characteristic test (Step S107), and the like. Thereafter, the magnetic recording medium is packed and shipped (Step S108). That is, because the performance check of the magnetic recording medium is performed after the film forming of the magnetic material, the surface treatment of the medium, and the like are performed and the surface smoothness test is complete, the medium need not be detached from a spindle motor, whereby the man-hour involved with the test is reduced. The electromagnetic property test explained at Step S17 in FIG. 12 can be performed after the performance check of the magnetic recording medium.

According to the first embodiment, on performing the performance check of the magnetic recording medium that records the signal according to the magnetization direction of the magnetic material during the manufacturing and the testing of the magnetic recording medium, the magnetic-recording-medium testing apparatus 10 analyzes the frequency characteristics of the reproduced signal in the preamble part of the servo signal after completion of the surface smoothness test, to estimate the cross sectional shape pattern of the magnetic recording medium based on the frequency characteristics. Accordingly, the quality testing of patterning of the magnetic material can be performed at a high speed and the servo operation can be stabilized when the magnetic recording medium is loaded in the magnetic recording apparatus.

That is, on performing the performance check of the magnetic recording medium that records the signal according to the magnetization direction of the magnetic material, the magnetic-recording-medium testing apparatus 10 can execute the performance check of the magnetic recording medium without adjusting the parameter for stabilizing the servo operation, thereby enabling to reduce the man-hour and the manufacturing cost involved with the performance check of the magnetic recording medium. Further, because the magnetic-recording-medium testing apparatus 10 can detect a servo pattern error beforehand due to a thickness change of the magnetic layer or deformation of the cross sectional shape pattern in one medium plane to exclude defective goods, the servo operation can be stabilized when the magnetic recording medium is loaded in the magnetic recording apparatus.

In the first embodiment, the magnetic-recording-medium testing apparatus that performs the performance check of the magnetic recording medium has been explained; however, the servo operation can be further stabilized in the magnetic recording apparatus having the magnetic recording medium incorporated therein, whose performance check is performed by the magnetic-recording-medium testing apparatus.

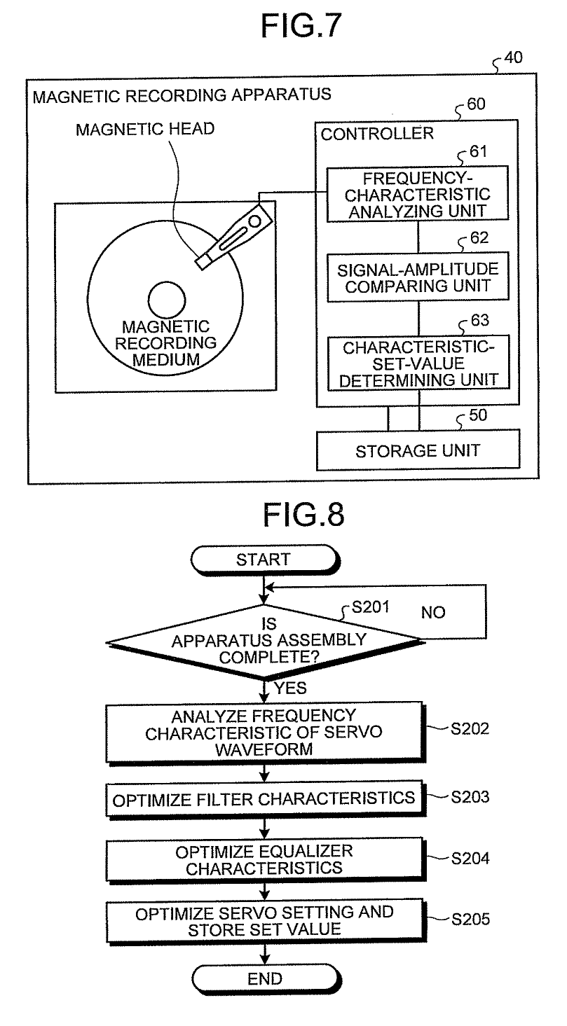

A process performed by a magnetic recording apparatus according to a second embodiment of the present invention is explained with reference to FIGS. 7 and 8. FIG. 7 depicts a configuration of the magnetic recording apparatus according to the second embodiment, and FIG. 8 is a flowchart for explaining a servo-characteristic-optimization process procedure performed by the magnetic recording apparatus.

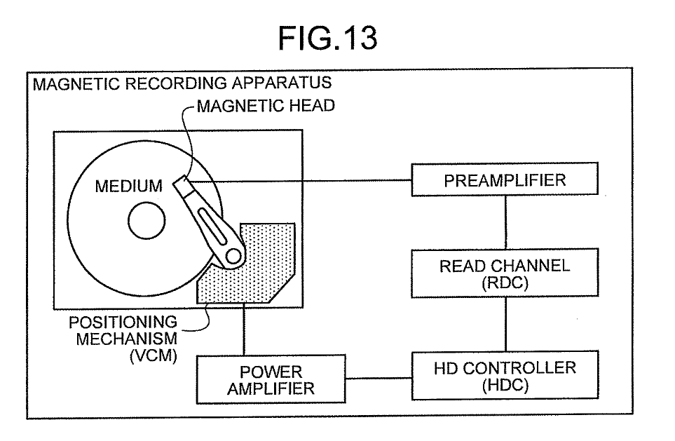

The configuration of a magnetic recording apparatus according to a conventional technique is explained with reference FIG. 13. The magnetic recording apparatus according to the conventional technique depicted in FIG. 13 includes a magnetic recording medium, a magnetic head that performs recording and reproduction, and a voice coil motor (VCM) that performs positioning of the magnetic head, in a housing of the magnetic recording apparatus. The magnetic recording apparatus further includes a read channel (RDC) for controlling a recording/reproduction signal, an HD controller (HDC) for controlling the operation of the magnetic recording apparatus, and a power amplifier (power controller) for driving the VCM according to a servo signal from the HDC, on a circuit base plate (not shown).

In such a configuration, a preamplifier is installed near the magnetic head to amplify a weak reproduced signal from the magnetic head and transmit the reproduced signal to the RDC. The RDC obtains the servo signal, the recording/reproduction signal, and the like via various filters and demodulates the signals. Subsequently, the HDC transmits the demodulated servo signal to the power amplifier as a positioning control signal (drive signal). The power amplifier then converts the control signal to an electric current to control the VCM.

The magnetic recording apparatus according to the conventional technique extracts a parameter for optimizing the servo characteristic at respective radius positions (respective zone positions) premised on that the servo signal characteristic does not largely change at the time of the conventional medium performance check. Accordingly, when the servo signal characteristic changes in the conventional medium plane or in one track, the conventional magnetic recording apparatus cannot set the parameter to an optimum value with respect to all the servo signals.

Therefore, an object of the second embodiment is to provide a magnetic recording apparatus capable of stably performing the servo operation by adapting to a change in the servo signal information of the magnetic recording medium manufactured according to the first embodiment.

The configuration of the magnetic recording apparatus according to the second embodiment is explained next. As depicted in FIG. 7, a magnetic recording apparatus 40 includes a storage unit 50, a controller 60, and a magnetic recording medium and a magnetic head that performs recording and reproduction in the housing of the magnetic recording apparatus 40. The magnetic recording medium and the magnetic head that performs recording and reproduction in the housing may not be necessarily included in the housing of the magnetic recording apparatus 40, and the magnetic recording apparatus 40 may be configured as a control apparatus which includes only the storage unit 50 and the controller 60.

The storage unit 50 stores data required for various processes performed by the controller 60 and various processing results obtained by the controller 60. The storage unit 50 stores set values such as a filter characteristics and equalizer characteristics determined by a characteristic-set-value determining unit 63 described later.

The controller 60 includes an internal memory for storing a program specifying various process procedures and required data, and also includes a frequency-characteristic analyzing unit 61, a signal-amplitude comparing unit 62, and the characteristic-set-value determining unit 63 as units closely associated with the present invention, and executes various processes by using these units.

The frequency-characteristic analyzing unit 61 analyzes the frequency characteristics of the reproduced signal in an area of the magnetic material where a continuous frequency signal is written. Specifically, the frequency-characteristic analyzing unit 61 obtains the reproduced signal in the preamble part, which is a top single frequency domain, of the servo signal used for the positioning control of the reproduction head of the magnetic recording medium. The frequency-characteristic analyzing unit 61 analyzes the frequency characteristics by the DFT calculation based on the obtained reproduced signal.

The signal-amplitude comparing unit 62 compares the signal amplitudes of the fundamental wave and the higher harmonic wave with each other based on the frequency characteristics analyzed by the frequency-characteristic analyzing unit 61. Specifically, the signal-amplitude comparing unit 62 compares the signal amplitudes of the fundamental wave and the higher harmonic wave with each other based on the frequency characteristics analyzed by the frequency-characteristic analyzing unit 61.

The characteristic-set-value determining unit 63 determines the set value of the filter characteristics and the equalizer characteristics for demodulating the magnetic recording signal based on the characteristics obtained by the comparison performed by the signal-amplitude comparing unit 62, stores the determined set value in a predetermined memory area, and demodulates the servo signal based on the determined set value.

More specifically, when the signal-amplitude comparing unit 62 compares the signal amplitudes, the characteristic-set-value determining unit 63 determines the set value corresponding to the cross sectional shape pattern of the magnetic material based on a selection range of the set value of the filter characteristics and the equalizer characteristics obtained by a shape difference occurring in the radius direction of the medium and a circumferential direction of the track due to a difference at the time of manufacturing the patterned magnetic material. That is, because a search range of the parameter to be optimized need not be extended beyond necessity, selection of the filter characteristics and the equalizer characteristics matched with the cross sectional shape pattern of the magnetic recording medium leads to reduction of the man-hour required for the search.

The characteristic-set-value determining unit 63 stores the determined filter setting and the equalizer setting in the storage unit 50, and uses these set values stored in the storage unit 50 as required for demodulating (controlling) the servo signal. The storage unit 50 has, for example, a random access memory (RAM) area such as a semiconductor memory and uses the RAM area as an area operating as a read only memory (ROM) after the set value is stored.

A servo-characteristic-optimization process procedure is explained next with reference to FIG. 8.

As illustrated in FIG. 8, when assembly of the magnetic recording apparatus 40 is complete (YES at Step S201), the magnetic recording apparatus 40 obtains a reproduced signal in the preamble part, which is a top single frequency domain, to analyze the frequency characteristics (Step S202). The magnetic recording apparatus 40 determines the set value of the filter characteristics and the equalizer characteristics based on the analyzed frequency characteristics to optimize an analog filter value and a finite impulse response (FIR) filter setting (Steps S203 and S204).

Subsequently, the magnetic recording apparatus 40 stores the determined set value in the storage unit 50, and uses the set value stored in the storage unit 50 to demodulate the servo signal thereby to optimize the servo setting (Step S205).

According to the second embodiment, the magnetic recording apparatus 40 analyzes the frequency characteristics of the reproduced signal in the preamble part of the servo signal, determines the parameter values of the filter characteristics, the equalizer characteristics, and the like based on the frequency characteristics, and stores the determined parameter value in the predetermined memory. Accordingly, the servo operation can be stabilized instantaneously by referring to the stored parameter value, when the magnetic head moves to a target track in the tracks on the magnetic recording medium.

In the second embodiment, the set values of the filter characteristics and the equalizer characteristics are determined based on the frequency characteristics analysis result of the reproduced signal obtained from the preamble part of the servo signal and stored in the predetermined memory. However, the present invention is not limited thereto, and the set values can be recorded in the servo area based on the determined set values.

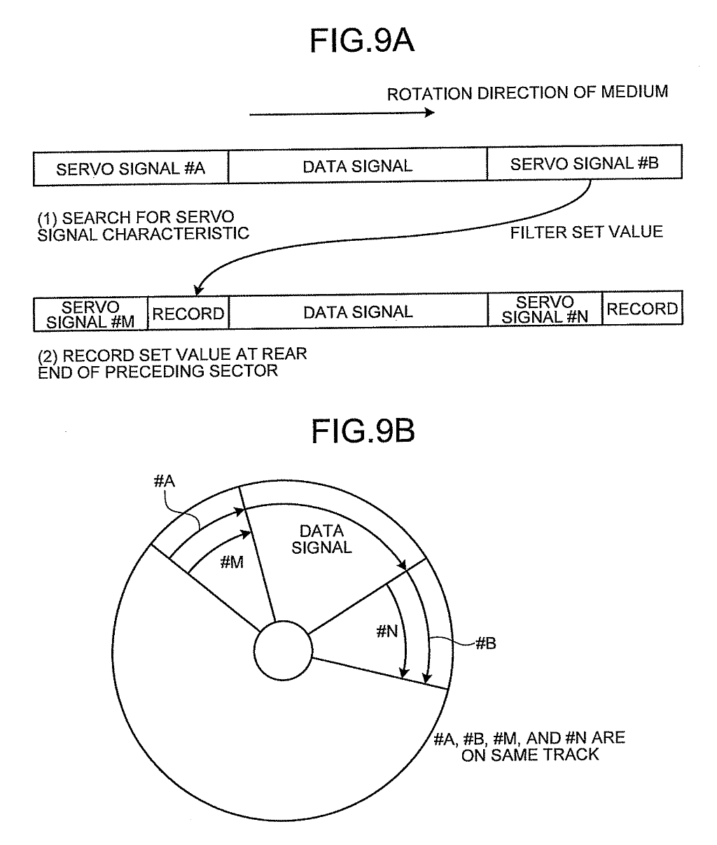

As a third embodiment, the optimization process of the servo setting performed by a magnetic recording apparatus according to the third embodiment of the present invention is explained with reference to FIGS. 9A and 9B. FIG. 9A is a schematic diagram for explaining an example in which a servo set value according to the third embodiment is recorded in the servo area, and FIG. 9B is an example of the magnetic recording medium according to the third embodiment. Because the configuration of the magnetic recording apparatus according to the third embodiment and a part of the function thereof are the same as those in the second embodiment, explanations thereof will not be repeated, and the optimization process of the servo setting different from that of the second embodiment is specifically explained.

As shown in FIG. 9A, the magnetic recording apparatus obtains the reproduced signal from the preamble part of the servo signal to analyze the frequency characteristics, as in the second embodiment, stores the filter set value obtained by the analysis in the predetermined memory, and optimizes a servo control parameter (see (1) in FIG. 9A).

The magnetic recording apparatus records the filter set value in a preceding sector of a searched servo area after storing the filter set value in the predetermined memory (see (2) in FIG. 9A). That is, the magnetic recording apparatus writes servo setting information for a subsequent sector by using a recording area for writing RRO information or the like of the servo signal. When there are many pieces of the RRO information, the magnetic recording apparatus can write only representative servo setting information in the top sector of the track, or can intermittently write the servo setting information in the sector.

For example, as shown in FIG. 9B, the magnetic recording apparatus searches for the frequency characteristics of servo signals #A and #B in the first round of the magnetic recording medium, then records the set values respectively at rear ends of servo signals #M and #N in the same sector in the second round of the magnetic recording medium. The servo signals #A, #B, #M, and #N are on the same track, however, the servo signals #A (first round) and #M (second round), and the servo signals #B (first round) and #N (second round) at the same position are illustrated separately from each other, for simplifying the explanation.

According to the third embodiment, the magnetic recording apparatus analyzes the frequency characteristics of the reproduced signal obtained from the preamble part of the servo signal and writes the obtained optimum parameter value in a recording area of the preceding servo area. Accordingly, the servo operation can be stabilized instantaneously by referring to the stored parameter value, when the magnetic head moves to respective tracks in the tracks on the magnetic recording medium.

In the second embodiment, the set values of the filter characteristics and the equalizer characteristics are determined based on the frequency characteristic analysis result of the reproduced signal obtained from the preamble part of the servo signal and stored in the predetermined memory. However, the present invention is not limited thereto, and the set values can be determined based on the frequency characteristic analysis result of the reproduced signal obtained from the preamble part of the servo signal at the time of operating the magnetic recording apparatus, and then demodulation of a servo mark and an address mark can be performed.

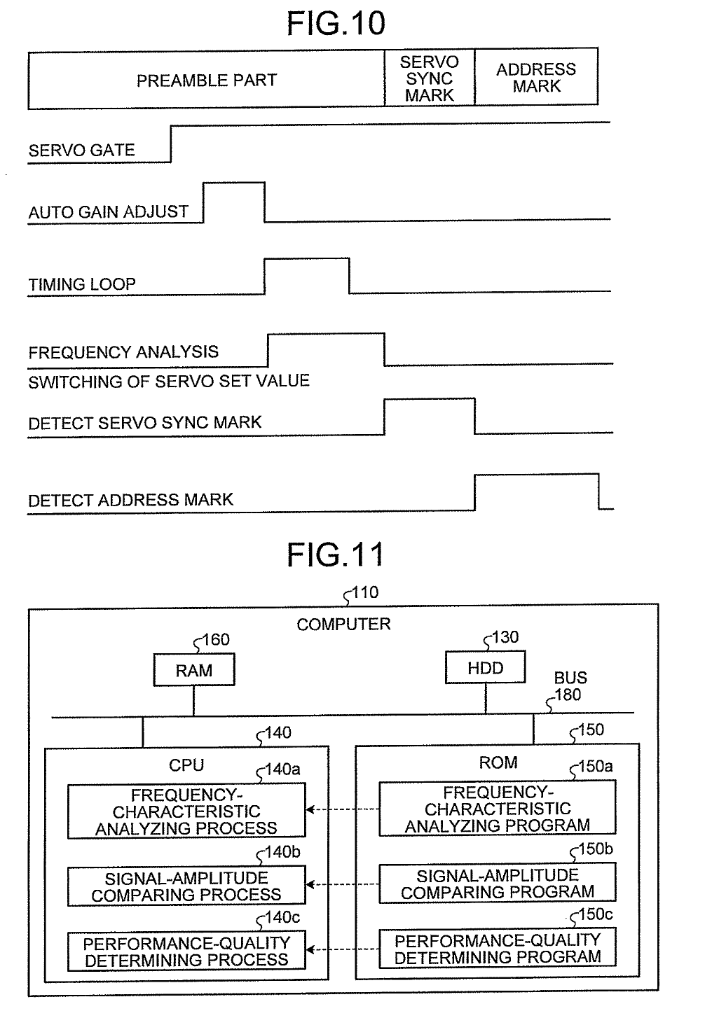

An optimization process of the servo setting performed by a magnetic recording apparatus according to a fourth embodiment of the present invention is explained with reference to FIG. 10. FIG. 10 is a timing chart of the servo signal optimization process according to the fourth embodiment at the time of a device operation. Because the configuration of the magnetic recording apparatus according to the fourth embodiment and a part of the function thereof are the same as those in the second embodiment, explanations thereof will not be repeated, and the optimization process of the servo setting different from that of the second embodiment is specifically explained.

As shown in FIG. 10, the magnetic recording apparatus reproduces the servo signal after a servo gate rises, to start demodulation. The magnetic recording apparatus adjusts a signal level gain in the preamble part of the servo signal (Auto Gain Adjust). Subsequently, the magnetic recording apparatus adjusts a clock of the servo signal to follow a single frequency (Timing Loop).

The magnetic recording apparatus analyzes the frequency characteristics of the reproduced signal in the preamble part, in parallel with timing synchronization with respect to the servo signal, to ascertain the characteristics of the cross sectional shape pattern of the magnetic material, and determines the parameter value most suitable for the demodulation of the servo signal. The magnetic recording apparatus then detects the servo mark and the address mark. As a result, the magnetic recording apparatus operates in a state having an excellent error rate at the time of demodulating the servo signal. For the determination of the parameter value, a demodulation operation is efficiently performed by preparing a plurality of representative settings beforehand. The determined parameter value is stored in the memory area of the magnetic recording apparatus, and the information is taken out occasionally every time the servo area is read.

According to the fourth embodiment, after the magnetic recording apparatus simplifies optimization of the parameter value of the servo signal performed at the time of the performance check of the magnetic recording medium and determines the parameter value at the time of operating the magnetic recording apparatus, the magnetic recording apparatus demodulates the servo signal, and thereafter, the magnetic recording apparatus demodulates the servo mark and the address mark, thereby enabling stable servo control.

While the embodiments of the present invention have been explained above, the present invention can be executed in various different forms other than the above embodiments. Accordingly, embodiments different in (1) configuration of the magnetic-recording-medium testing apparatus and (2) a program are explained below.

### (1) Configuration of the Magnetic-Recording-Medium Testing Apparatus

The process procedures, control procedures, specific names, and information including various pieces of data and parameters (for example, specific names such as the “signal-amplitude comparing unit 32” depicted in FIG. 2) described in the specification and the drawings can be arbitrarily changed, unless otherwise specified.

The respective constituent elements of the illustrated units are functionally conceptual, and physically the same configuration as depicted in the drawings is not necessary. That is, a specific form of division and integration of respective units is not limited to the ones depicted in the drawings. For example, the entirety or a part of the signal-amplitude comparing unit 32 can be functionally or physically divided or integrated in an arbitrary unit according to various loads or the status of use, such that the signal-amplitude comparing unit 32 is divided into a signal-amplitude comparing unit that compares the signal amplitudes of the fundamental wave and the higher-harmonic wave with each other based on the frequency characteristics and a cross sectional shape pattern estimating unit that estimates the cross sectional shape pattern based on the compared signal amplitudes. The entirety or an arbitrary part of the respective processing functions performed by these units can be realized by a central processing unit (CPU) and a program analyzed and executed by the CPU, or can be realized as hardware by a wired logic.

### (2) Program

In the above embodiments, a case that the various processes are realized by the hardware logic has been explained, however, the present invention is not limited thereto, and various processes can be realized by executing a program prepared beforehand by a computer. One example of the computer that executes a magnetic-recording-medium testing program having the same functions as those of the magnetic-recording-medium testing apparatus 10 described in the above embodiments is explained with reference to FIG. 11. FIG. 11 depicts the computer that executes the magnetic-recording-medium testing program.

As depicted in FIG. 11, in a computer 110 as the magnetic-recording-medium testing apparatus, a hard disk drive (HDD) 130, a CPU 140, a ROM 150, and a RAM 160 are connected to each other by a bus 180.

The ROM 150 stores beforehand the magnetic-recording-medium testing program that demonstrates the same functions as those of the magnetic-recording-medium testing apparatus 10 described as the first embodiment, that is, a frequency-characteristic analyzing program 150a, a signal-amplitude comparing program 150b, and a performance-quality determining program 150c. These programs 150a to 150c can be appropriately integrated or divided as in the respective constituent elements of the magnetic-recording-medium testing apparatus 10 depicted in FIG. 2.

As shown in FIG. 11, because the CPU 140 reads these programs 150a to 150c from the ROM 150 and executes these programs, the respective programs 150a to 150c function as a frequency-characteristic analyzing process 140a, a signal-amplitude comparing process 140b, and a performance-quality determining process 140c. The respective processes 140a to 140c correspond to the frequency-characteristic analyzing unit 31, the signal-amplitude comparing unit 32, and the performance-quality determining unit 33 depicted in FIG. 2.

The CPU 140 executes the magnetic-recording-medium testing program based on the data stored in the RAM 160.

According to an embodiment, the quality testing of patterning of the magnetic material can be performed at a high speed and the servo operation can be stabilized when the magnetic recording medium is loaded in the magnetic recording apparatus.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A magnetic-recording-medium testing apparatus comprising:
a frequency-characteristic analyzing unit that analyzes a frequency characteristic of a reproduced signal in an area of a magnetic material where a continuous frequency signal is written, in a magnetic recording medium that records a signal according to a magnetization direction of the magnetic material;
a signal-amplitude comparing unit that compares signal amplitudes of a fundamental wave and a higher harmonic wave with each other based on the frequency characteristic analyzed by the frequency-characteristic analyzing unit, to estimate a cross sectional shape pattern of the magnetic recording medium; and
a performance-quality determining unit that determines performance quality of the magnetic recording medium based on the cross sectional shape pattern of the magnetic recording medium estimated by the signal-amplitude comparing unit.

2. The magnetic-recording-medium testing apparatus according to claim 1, wherein the frequency-characteristic analyzing unit analyzes the frequency characteristic of the reproduced signal in a preamble part, which is a top single frequency signal, of a servo signal area where the continuous frequency signal is written on the magnetic material.

3. The magnetic-recording-medium testing apparatus according to claim 1, wherein a medium test by the magnetic-recording-medium testing apparatus is executed after a surface smoothness test of the magnetic recording medium.

4. A magnetic recording apparatus that records a signal according to a magnetization direction of a magnetic material, comprising:
a frequency-characteristic analyzing unit that analyzes a frequency characteristic of a reproduced signal in an area of the magnetic material where a continuous frequency signal is written;
a signal-amplitude comparing unit that compares signal amplitudes of a fundamental wave and a higher harmonic wave with each other in the frequency characteristic analyzed by the frequency-characteristic analyzing unit; and
a characteristic-set-value determining unit that determines set values of filter characteristics and equalizer characteristics for demodulating a magnetic recording signal according to characteristics obtained by comparison performed by the signal-amplitude comparing unit, stores the determined set values in a predetermined memory area, and demodulates a servo signal based on the determined set values.

5. The magnetic recording apparatus according to claim 4, wherein the characteristic-set-value determining unit stores the determined set values of the filter characteristics and equalizer characteristics in an information recording area of magnetic recording signals on the magnetic recording medium.

6. The magnetic recording apparatus according to claim 4, wherein the characteristic-set-value determining unit uses the set values of the filter characteristics and equalizer characteristics stored in the predetermined memory area to demodulate the servo signal continuously in an operating state of the magnetic recording apparatus.

7. A magnetic-recording-medium testing method comprising:
analyzing a frequency characteristic of a reproduced signal in an area of a magnetic material where a continuous frequency signal is written, in a magnetic recording medium that records a signal according to a magnetization direction of the magnetic material;
comparing signal amplitudes of a fundamental wave and a higher harmonic wave with each other based on the frequency characteristic analyzed in the analyzing, to estimate a cross sectional shape pattern of the magnetic recording medium; and
determining performance quality of the magnetic recording medium based on the cross sectional shape pattern of the magnetic recording medium estimated in the comparing.
